(19) United States
(12) Patent Application Publication
(10) Pub. No.: US 2026/0061716 A1
(43) Pub. Date: Mar. 5, 2026

(54) Multi-Roller System with Low Pressure Material Supply

(71) Applicant: Matthews International GmbH, Vreden (DE)

(72) Inventors: Thomas HACKFORT, Vreden (DE); Thorsten BÖING, Vreden (DE); Harald BARTSCH, Vreden (DE); Phillip RÖRING, Vreden (DE); Tobias WILLEMSEN, Vreden (DE); Christoph LANSING, Vreden (DE); Ronny SCHLEGEL, Vreden (DE); Porter MITCHELL, Vreden (DE)

(21) Appl. No.: 19/316,043

(22) Filed: Sep. 2, 2025

(30) Foreign Application Priority Data
Sep. 4, 2024 (DE) 10 2024 125 339.8

(51) Int. Cl. B30B 11/22; H01M 4/04

(52) U.S. Cl. CPC B30B 11/22; H01M 4/0435

(57) ABSTRACT

This invention relates to a multi-roller system comprising at least two rollers forming at least one first gap therebetween configured to be supplied with at least one powder material to produce at least one film material and/or web material by compressing the powder material within the first gap, wherein at least one first low pressure area is provided in at least one supply area for the powder material and the first gap, wherein at least one sealing system is provided to seal the first low pressure area, wherein the sealing system contacts at least one surface of at least one of the rollers, wherein further a first roller is movable relative to a second roller to alter a width of the first gap and/or to alter a distance between the first roller and the second rollers, wherein the sealing system is adjustable to at least two different widths of the first gap and/or two distances of the first roller and the second roller.

### CROSS-REFERENCE TO RELATED APPLICATIONS

The present application claims priority to German Patent Application No. 10 2024 125 339.8 filed Sep. 4, 2024, which is incorporated herein by reference in its entirety.

### DESCRIPTION

The present claimed subject matter is direct to a multi-roller system comprising at least two rollers forming at least one first gap therebetween configured to be supplied with at least one powder material to produce at least one film material and/or web material by compressing the powder material within the first gap, wherein at least one first low pressure area is provided in at least one supply area for the powder material and the first gap, wherein at least one sealing system is provided to seal the first low pressure area, wherein the sealing system contacts at least one surface of at least one of the rollers.

In the prior art different multi-roller systems to produce material films and/or webs have been proposed. For example, EP 3 912 206 A2 discloses a system and method for manufacturing a dry electrode using a multi-roller system.

In such systems the material to be processed, in particular compressed, into a material film and/or web is provided in powder form. Due to this consistency of the material there is air existing between the powder particles that has to exit the material stream before being pressed between the rollers of the system. In case of increasing process speeds the air is trapped within the material flow leading to unwanted irregularities within the material and the procedure material film. To avoid such pores it is possible to press out these pores in the produced film, making however the use of a separate pressing step after the production of the film necessary or producing a counter-pressure that has to be compensated by the multi-roller system. Both leads to an increased effort and prevents higher process speeds as the air cannot escape fast enough due to its inertia.

To avoid such air traps, leading to increased porosity and defects in the produced film/web, it has been proposed to convey the powder material through a low pressure or vacuum area before and when it enters the multi-roller system. For example, such a system is described in WO 2020/007754 A1 disclosing a method and device for producing an electrode material strip.

The described system has however the drawback that an adaptation of the device to different target thicknesses of the produced material film is not possible, at least a complex adaptation of the device is necessary leading to unwanted production interruptions and thus higher costs.

It is thus the object of the claimed subject matter to further develop the known multi-roller systems to allow high production speeds and simultaneously an easy adaption of the system to wanted target thicknesses of the produced film.

This object is achieved by a multi-roller system comprising at least two rollers forming at least one first gap therebetween configured to be supplied with at least one powder material to produce at least one film material and/or web material by compressing the powder material within the first gap, wherein at least one first low pressure area is provided in at least one supply area for the powder material and the first gap, wherein at least one sealing system is provided to seal the first low pressure area, wherein the sealing system contacts at least one surface of at least one of the rollers, wherein further a first roller is movable relative to a second roller to alter a width of the first gap and/or to alter a distance between the first roller and the second rollers wherein the sealing system is adjustable to at least two different widths of the first gap and/or two distances of the first roller and the second roller.

It is preferred that at least one first roller is rotating around a first axis and at least one second roller is rotating around a second axis, wherein optionally the first axis and the second axis are at least partly parallel to each other.

It is also proposed that the sealing system comprises at least one sealing component, wherein the sealing component seals the first low pressure area relative to at least a part of the environment of the multi-roller system, in particular at an end face of the rollers, optionally the first roller and/or the second roller, and/or has at least one sealing surface having a normal vector parallel to an axial direction of the first axis and/or the second axis.

Preferred embodiments of the Multi-roller system can be characterized in that the sealing component comprises at least one first sealing component with a first sealing surface and at least one second sealing component with a second sealing surface, wherein optionally the first sealing component and the second sealing component are at least partly connected to each other or at partly formed as a single piece.

It is furthermore proposed that the first roller has at least one first counter surface and the second roller has at least one second counter surface, wherein optionally the first counter surface contacts the sealing component, optionally the sealing surface, optionally the first counter surface contacts the first sealing component, optionally the first sealing surface, and/or the second counter surface contacts the second sealing component, optionally the second sealing surface.

For the before described embodiments it is preferred that the first axis and/or the second axis is/are at least partly reaching through the sealing component, at least one opening within the sealing component, optionally the first axis is at least partly reaching through the first sealing component, optionally a first opening within the first sealing component, and/or the second axis is at least partly reaching through the second sealing component, optionally a second opening within the second sealing component.

Additionally it is proposed that the opening, optionally the first opening and/or the second opening, is at least partly elongated, optionally elliptical, optionally the first opening is at least partly elongated, optionally elliptical, and the second opening is at least partly circular or the second opening is at least partly elongated, optionally elliptical, and the first opening is at least partly circular.

Preferred embodiments can be characterized in that the sealing surface, optionally the first sealing surface and/or the second sealing surface, is at least partly elongated, optionally elliptical, optionally the first opening and the first sealing surface are at least partly elongated, optionally elliptical, and the second opening and the second sealing surface are at least partly circular, or the second opening and the second sealing surface are at least partly elongated, optionally elliptical, and the first opening and the first sealing surface are at least partly circular.

It is also proposed that the first counter surface and/or the second counter surface comprises at least one counter material, optionally at least one ceramic material, at least one metal material, at least one plastic material, at least one hardened material, hardened steel, at least one glass material, at least one polymer material, at least one polyether ether ketone material, at least one alloy material, at least one tungsten nitride material and/or at least one wolfram carbide material, and/or the first counter surface comprises at least one coating of at least a part of the first roller, optionally the end face of the first roller, and/or the second counter surface comprises at least one coating of at least a part of the second roller, optionally the end face of the second roller, and/or the first counter surface comprises at least one first counter surface element attached, optionally attached in a turnable safe manner, to the first roller, optionally the end face of the first roller, and/or the second counter surface comprises at least one second counter surface element attached, optionally attached in a turnable safe manner, to the second roller, optionally the end face of the second roller.

Furthermore it is preferred that the sealing system, optionally the sealing component, comprises at least one retaining element, wherein optionally the retaining element forces/biases a sealing component means, optionally the sealing surface, onto the first counter surface and the second counter surface, optionally the retaining element comprises at least one first retaining element forcing/biasing the first sealing component, optionally the first sealing surface, onto the first counter surface, and/or at least one second retaining element forcing/biasing the second sealing component, optionally the second sealing surface, onto the second counter surface.

For the before described embodiment it is proposed that the first retaining element is movable relative to the second retaining element, optionally in a radial direction of the first axis and/or the second axis and/or a direction perpendicular to the first axis and/or the second axis.

Additionally, it is proposed that the first retaining element and the second retaining element are guided relative to each other, optionally by at least one tongue and groove connection.

Also it is preferred that the first retaining element is securely connected in a longitudinal direction perpendicular to the first axis to the first axis and/or the second retaining element is securely connected in a longitudinal direction perpendicular to the second axis to the second axis and/or the first axis is turnable mounted within the first retaining element, preferably by at least one first sealing bearing and/or the second axis is turnable mounted within the second retaining element, preferably by at least one second sealing bearing.

Furthermore it is proposed that the first bearing element is held relative to and/or within the first retaining element by at least one first fastening element and/or the second bearing element is held relative to and/or within the second retaining element by at least one second fastening element.

Advantageous embodiments can be characterized in that the sealing component, optionally the sealing surface, in particular the first sealing component and/or the second sealing component, optionally the first sealing surface and/or the second sealing surface, comprises at least partly at least one second material, optionally, at least one metal material, at least one plastic material, at least one hardened material, hardened steel, at least one glass material, at least one polymer material, at least one polyether ether ketone material, at least one alloy material, at least one tungsten nitride material and/or at least one wolfram carbide material, in particular in an area contacting the first counter surface and/or the second counter surface.

Furthermore it is proposed that the sealing system comprises at least one sealing element, optionally sliding sealing element, wherein the sealing element seals the first low pressure area, in particular relative to at least a part of the environment of the multi-roller system, along a rolling surface of the roller, optionally by sliding at least partly on at least a part of the rolling surface of the roller, and/or has at least one contact surface with at least one of the rollers, in particular a rolling surface-, extending parallel to the first axis and/or the second in axis, and/or having a normal vector perpendicular to an axial direction of the first axis and/or the second axis.

For the before described alternative it is preferred that the sealing element, optionally a sealing element means of the sealing element is movable in a direction onto the rolling surface of the first roller and/or the second roller and/or perpendicular to the first axis and/or the second axis and/or the sealing element, optionally the sealing element means is forced onto the surface of the first roller and/or the second roller, optionally by at least one biasing and/or spring element.

It is also suggested that the direction of movement of the sealing element, optionally the sealing element means and the normal direction of the contact surface of the rolling surface of the first roller and/or the second roller
(i) enclose a first angle, optionally angle of attack, in a first relative position of the first roller and the second roller, a first relative position of the first axis and the second axis and/or a first width of the first gap, and
(ii) enclose a second angle, optionally angle of attack, in a second relative position of the first roller and the second roller, a second relative position of the first axis and the second axis and/or a second width of the first gap,
wherein the first angle and the second angle are different.

Alternatively or additionally it is proposed that the sealing element comprises at least two sealing element parts that are movable relative to each other in a direction at least partly parallel to the first axis and/or the second axis.

Preferred embodiments can be characterized in that the sealing element comprises a first sealing element, optionally a first sliding sealing element, contacting, in particular glidingly, the first roller, optionally the rolling surface of the first roller, and at least one second sealing element, optionally a second sliding sealing element, contacting, in particular glidingly, the second roller, optionally the rolling surface of the second roller.

It is also suggested that the system comprises at least one second low pressure area being located opposite the first low pressure area and/or the supply area relative to the first roller and/or the second roller and/or opposite the first low pressure area and/or the supply area relative to the first gap.

Also it is proposed that within the first low pressure area a first pressure is present and in the second low pressure area a second pressure is present, wherein optionally the first pressure and the second pressure are blow a pressure in the environment of the multi-roller system and/or wherein optionally the first pressure is lower than the second pressure.

In a further suggested embodiment the multi-roller system comprises at least one third roller, wherein optionally at least one second gap is formed
(i) between the first roller and the third roller,
(ii) between the second roller and the third roller, or
(iii) between the third roller and a fourth roller,
and/or material exiting the first gap is conveyed through the second gap.

Finally a multi-roller system can be characterized by at least one vacuum pump connected to the first low pressure area and/or the second low pressure area, optionally at least one first vacuum pump connected to the first low pressure area and/or at least one second vacuum pump being connected to the second low pressure area.

Thus, the claimed subject matter is based on the astonishing perception that a multi-roller system can be provided with a low pressure supply for a powder material of a gap of the roller system to allow high production speeds without adding trapped air and pores within the produced film and simultaneously allow an easy and uncomplex adjustment of the roller-system to the target thickness of the film and/or web to be produced in that the roller gap can be adjusted without the further need of replacing a sealing for the lower pressure area in that the sealing both in the axial as well as radial direction of at least one roller is adjustable.

In the following description the wording of a width of a gap between two rollers is to be understood as the geometric expansion of the gap and/or the distance of the roller surfaces in a direction perpendicular to rotational axes of the rollers. Optionally the width of the gap defines a thickness of the produced film and/or web. The wording of a length of a gap has to be understood as a geometric expansion of the gap parallel to the rollers, in particular the rotational axes of the rollers. The length of the gap optionally defines the width of the produced film and/or web.

The use of a sealing component as described above has the effect that the first low pressure area can be sealed at an end face and/or lateral ends of the respective rollers and the longitudinal sides of the area can be sealed by sealing elements. This allows the first low pressure area to be limited at the bottom by the rollers in such a way that due to the adaptability of the sealing system, in particular the sealing component and/or the sealing element, the distance between the rollers and/or the width of the first gap can be changed without negatively influencing the pressure within the first low pressure area.

By locating a powder material supply within the first low pressure area the powder feed area to the rollers can be kept at a low pressure, optionally at vacuum, for example at a pressure below 700 mbar, preferably at or below 300 mbar, more preferably at or below 10 mbar. By using a non-circular opening within the sealing component it is possible that the roller can be moved relative to the sealing component without the sealing surface loosing contact with the counter surface, but remaining in contact with the counter surface in the region of the first low pressure region around the first axis or second axis. Outside the first low pressure area the contact surface and the counter surface might loose contact without negatively influencing the reduced pressure within the first low pressure area.

The use of different materials as counter material and sealing material, in particular materials having different wear resistances, allows to control which element might be sacrificed and replaced. Foe example a counter material for the counter surface that has a greater wear resistance, optionally a greater hardness, than a material of the sealing surface, for example a ceramic material as counter material and a plastic material for the material of the sealing surface, has the advantage that wear is occurring at the sealing surface that can be easily replaced compared to the counter surface as the complete removal or exchange of the roller would be necessary to replace the counter surface. Such a replacement of the roller would make a new calibration balancing and the like necessary. The sealing surface can be replaced by replacing the part of the sealing component being separate from the roller.

The use of the retaining element ensures that any variation and wear in the sealing surface or counter surface can be compensated by biasing the sealing surface onto the counter surface. Furthermore, the use of separate retaining elements allows a movement of the retaining elements relative to each other to compensate for a relative movement of the rollers to alter the width of the first gap.

The use of a movable sealing element to seal the first low pressure area with respect to the environment along the rolling surface of the rollers allows to ensure also a reliable sealing for different widths of the first gap, i.e. different distances of the rollers versus stationary sealing devices. In particular the use of a sliding sealing element allows to ensure a reliable sealing contact of the sealing element with the rolling surface, in particular the contact surface. When at least one of the rollers is moved in a direction perpendicular to the axis and perpendicular to a moving direction of the sealing element the sealing element is moved to compensate a distance change between an attachment means of the sealing element to a support structure on the one hand and the surface of the roller, optionally the contact surface, on the other hand due to the curvature of the rolling surface. Thus a change of the angle of attack of the sealing element on the rolling surface of the roller due to a movement of the roller relative to the sealing element can be compensated without negatively influencing the sealing properties.

In a first embodiment the film and/or web produced by compressing the powder material exits the first gap at atmospheric pressure. To further reduce the effects of the pressure difference between the pressure within the first low pressure area and the environment of the multi-roller system, in particular in the area of the gap that might lead to turbulences within the powder material in the area of the first gap the use of a second low pressure area is proposed. It is proposed that a second low pressure area is formed on the side of the gap opposite the supply area. The film material/web is conveyed with the help of at least one third roller to the environment. Preferably the film is conveyed through a second gap formed between the first or second roller on the one side and the third roller on the other side. Alternatively the second gap is formed between the third roller and a further fourth roller.

Any air that is entering the second gap comes into contact with the film/web and not with a powder material. This extincts, at least reduces the impact of powder turbulences in the area of the first gap, in particular when the first gap has a maximum width.

The claimed multi-roller system can be used for any material that can form a material film and/or web from powder material, wherein the powder can be a dry powder, a quasi-dry powder, a moist powder or the like. One area of application is for example the production of anode or cathode material in the battery industry.

Further features and advantages of the claimed subject matter will become apparent from the following description of embodiments of the claimed subject matter with the help of the enclosed figures, wherein

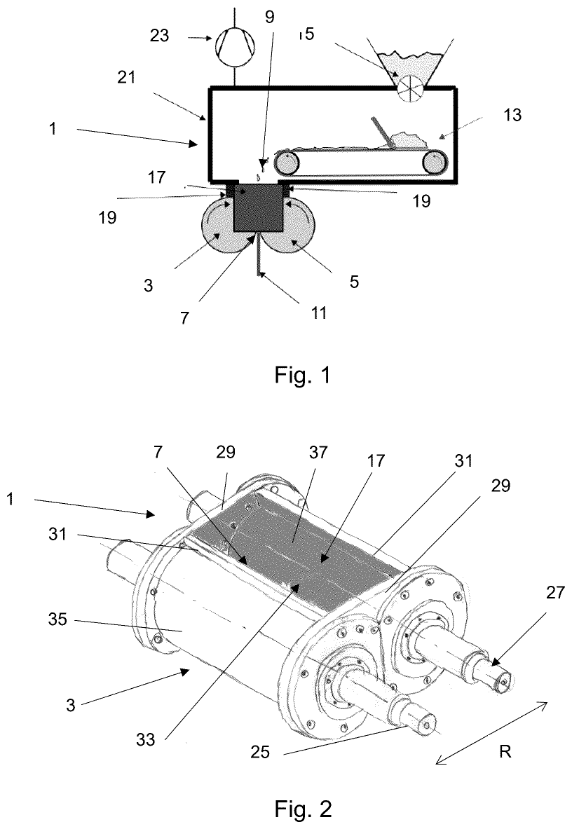

FIG. 1 shows a schematic cross-sectional view of a first embodiment of a multi-roller system according to the claimed subject matter;

FIG. 2 shows a perspective view onto the multi-roller system of FIG. 1;

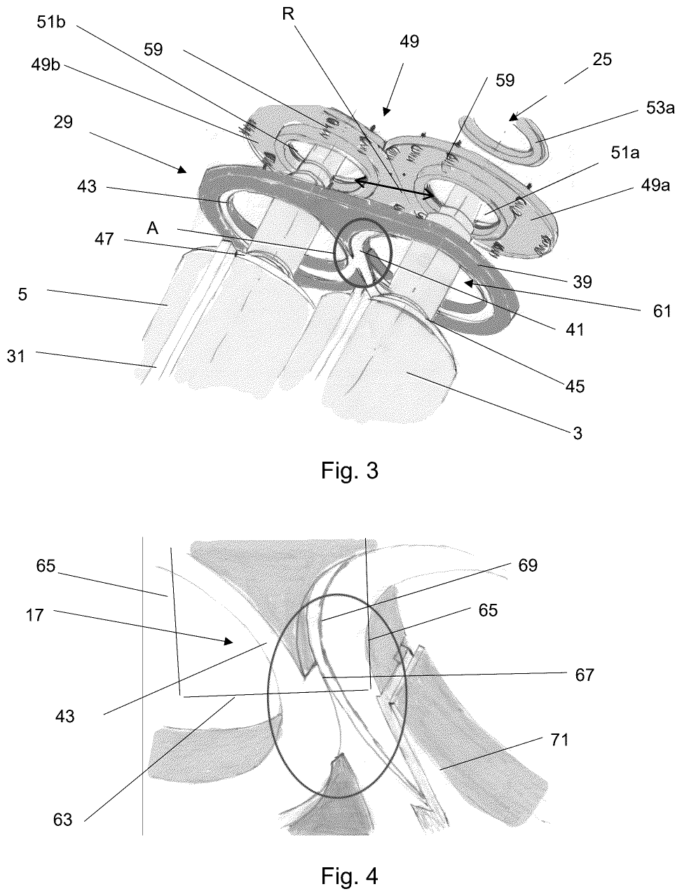

FIG. 3 shows an exploded view of a sealing component of the multi-roller system of FIGS. 1 and 2;

FIG. 4 shows a view of detail A of FIG. 3;

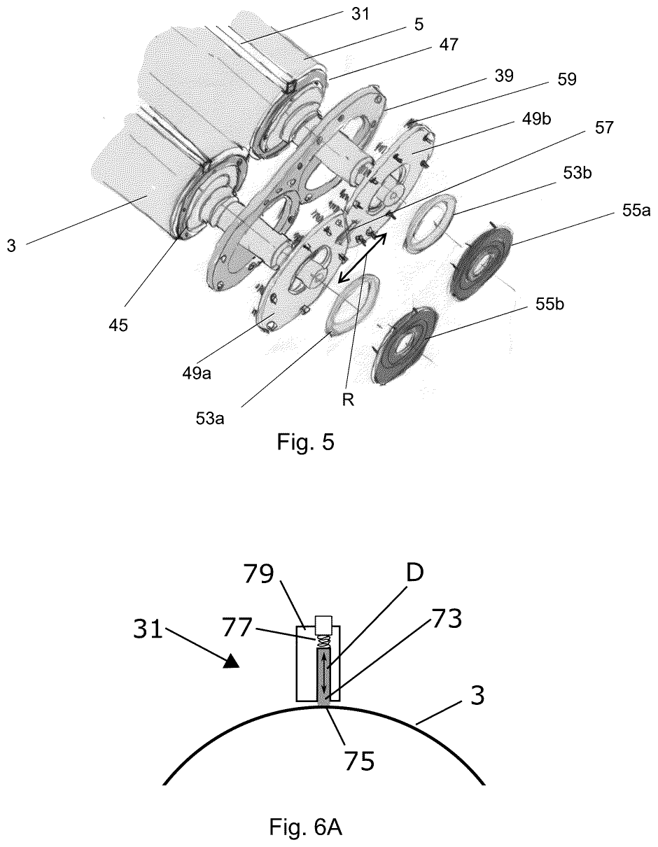

FIG. 5 shows a further exploded view of the sealing component of the multi-roller system of FIGS. 1 to 4;

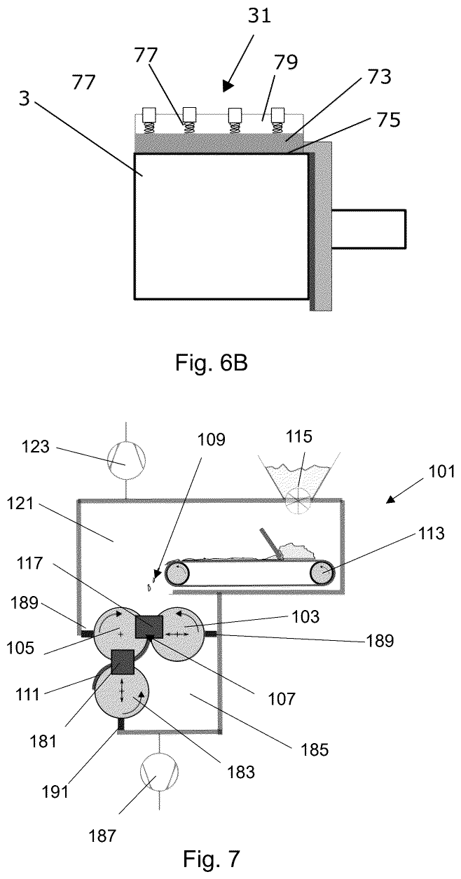

FIG. 6a, 6b show detail views of a sealing element of the multi-roller system of FIGS. 1 to 5;

FIG. 7 shows a schematic cross-sectional view of a second embodiment of a multi-roller system according to the claimed subject matter having two low pressure areas;

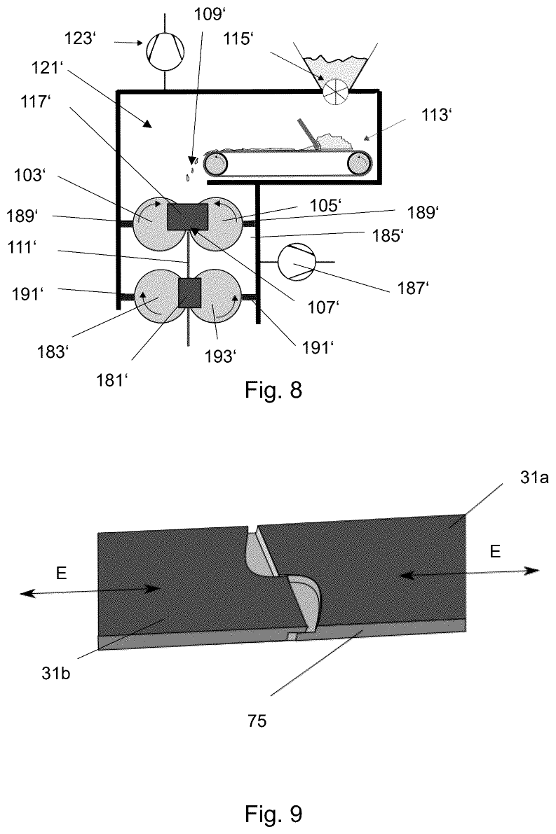

FIG. 8 shows a schematic cross-sectional view of a third embodiment of a multi-roller system according to the claimed subject matter having two low pressure areas; and

FIG. 9 shows a detail view onto a preferred alternative of a sealing element.

FIG. 1 shows a schematic cross-sectional view of a first embodiment of a multi-roller system 1 according to the claimed subject matter. The multi-roller system 1 comprises a first roller 3 and a second roller 5. The rollers 3, 5 form a gap 7 therebetween. A powder material 9 is supplied to the gap 7. In particular the powder is supplied along the complete, at least nearly the complete length of the gap 7. By the rollers 3, 5, the material is compressed into a film and/or web 11. The material 7 is supplied to the rollers 3,5, and the gap 7, respectively, by a conveyer device 13 that conveys the material 7 from a powder material feed 15, in particular an airlock, to the gap 7.

In the region of the rollers 3, 5 and the gap 7, respectively, a first low pressure area 17 is provided. As explained below, the low pressure area 17 is sealed against the environment of the multi-roller system 1, in particular atmospheric pressure by a sealing system 19. The low pressure area 17 is fluidly connected and/or opened to a low pressure chamber 21, wherein for example the conveyor device 13 is located and into which an outlet of the powder material feed opens. Although the low pressure area 17 and the low pressure chamber are depicted as separate elements, they can be combined with each other and can form a single piece. Within the low pressure chamber 21 and the low pressure area 17 a pressure below the pressure within the environment of the multi-roller system 1, in particular below atmospheric pressure is generated. For example the pressure might be below 700 mbar, preferably below 300 mbar, more preferably below 10 mbar or below 5 mbar, up to a vacuum. This lower pressure is generated by a vacuum pump 23 being connected to the low pressure chamber 21 and/or the low pressure area 17.

The multi-roller system 1 allows the powder material feed area as well at the side of the gap 7 to be kept under low pressure, up to a vacuum by using a sealing system described below. The sealing system allows to seal the low pressure area 17 by providing sealing components allowing a sealing a lateral boundaries of the rollers 3, 5 as well as by providing sealing elements at a boundary to a rolling surface of the rollers 3, 5 at the side of the gap 7 into which the powder material 9 is fed. Thus, the powder material is fed into the gap 7 between the rollers 3, 5 at low pressure before being formed into the film and/or web 11 by compression forces within the gap 7 provided by the rollers 3, 5. The web 11 leaves the gap 7 at atmospheric pressure. Thus, it is avoided that there is air between the powder particles, which would be trapped in the web as pores. As a pressing out of the air can be avoided higher process speeds can be realized as no, at least less, air has to escape. Generally, the porosity and the number of defects in the web 11 can be reduced.

FIG. 2 shows a perspective view onto the multi-roller system 1. As shown in FIG. 2 the first roller 3 is rotating around a first axis 25 whereas the second roller 5 is rotating around a second axis 27. The low pressure area 17 is surrounded by the sealing system 19 comprising sealing components 29 and sealing elements 31. The length of the gap 7 is in particular defined as the geometric expansion of the gap along the rotational axes 25, 27 between the sealing components. In FIG. 2 the opening 33 of the low pressure area 17 to the low pressure chamber 21 is shown. The boundary of the low pressure area 17 opposite the low pressure chamber 21 and the opening 33, respectively is formed by the rollers 3, 5, in particular the rolling surface 35 of the first roller 3 and the rolling surface 37 of the second roller 5. Preferably the powder material 9 is supplied of the complete length, at least nearly the complete length, of the gap 7 into the gap 7. By this measure it is avoided that an opening is provided at the ends of the length of the gap 7 close to the sealing components 31. Such an opening would provide a connection between the environment, in particular atmospheric pressure, on the one hand and the low pressure area 17 and low pressure chamber 21, respectively, on the other hand leading to a pressure equalization and turbulences in the powder material 9 in these areas.

As explained above it is essential that the gap 7, in particular its width, is adjustable to adapt the characteristics of the web 11, in particular its thickness, density and the like. As explained below, the sealing system 19, in particular the sealing component 29 and/or the sealing element 31, is/are configured to be adjustable to allow an adjustment of the gap 7 without negatively impacting the sealing properties of the sealing system 19.

FIG. 3 shows an exploded view onto a sealing component 29. The sealing component 29 comprises a sealing component means 39, optionally comprising a plastic material like polyether ether ketone (PEEK) material. Within the sealing component means 39 a first sealing surface 41 and a second sealing surface 43 are formed. The first sealing surface 41 contacts a first counter surface 45 located at the first roller 3, in particular its end face, whereas the second sealing surface 43 contacts a second counter surface 47 located at the second roller 5, in particular its end face. The counter surfaces 45, 47 can be formed as separate elements connected to the first roller 3 and second roller 5, respectively, or can be realized as coating on the end face of the roller 3 and the roller 5, respectively. As separate elements for example discs can be used. Such discs can be secured to the respective roller 3, 5 permanently by respective pressure rings. To prevent leaks on the side of the discs facing the roller end face respective O-rings can be used in this area, i.e. an area between the disc and the end face.

The counter surfaces 45, 47 comprise preferably a counter material having an increased hardness compared to the sealing surfaces 41, 43, like a ceramic material.

The sealing component 29 furthermore comprises a retaining element 49 comprising a first retaining element 49a and a second retaining element 49b. As shown in FIG. 5 the first axis 25 is rotatably supported within an opening 51a of the retaining element 49a with the help of a bearing element 53a, in particular sealing bearing, whereas the second axis 27 is rotatably supported within an opening 51b of the retaining element 49b with the help of a bearing element 53b, in particular sealing bearing. The bearing elements 51a, 51b are connected to the respective retaining element 49a, 49b with the help of fastening elements 55a, 55b, respectively.

To allow a relative movement of the rollers 3,5 to adjust the width of the gap 7, the retaining elements 49a, 49b are formed a separate parts being movable with respect to each other. In the shown embodiment the retaining elements 49a, 49b are however guided with respect to each other by a tongue-groove connection 57, in particular in a direction perpendicular to the axes 25, 27, optionally in a plane comprising the axes 25, 27.

The sealing component means 39 is forced onto the counter surfaces 45, 47 by biasing means in form of spring elements 59 to ensure a sealing contact between the sealing surfaces 41, 43 and the counter surfaces 45, 47. Furthermore a defined guide of the sealing component means 39 is ensured. The retaining elements 49a, 49b might be connected to respective torque supports of the rollers 3, 5, respectively.

In the shown embodiment the first roller 3 is moved relative to the second roller 5 to adjust the width of the gap 7. In other words, the axis 27 remains unchanged in space, whereas the first axis 25 is moved in a radial direction R of the axis 25 within the space i.e. the roller 5 represents a fixed roller, whereas the first roller represents a loose roller.

In such a configuration the counter surface 47 stays in contact with the radial symmetrically formed sealing surface 43. The sealing surface 41 has an elongated form and an opening 61 within the sealing component means 39 is also elongate in form. This allows a movement of the axis 25, optionally a roller journal of the first roller 3, within the opening 61. Furthermore, the counter surface 45 remains in contact with the sealing surface 41 in the region that is covered by the low pressure area 17.

In FIG. 4 the detail A of FIG. 3 is shown. A horizontal border 63 and a vertical border of the low pressure area 17 are shown in FIG. 4. Furthermore, a first projection 67 of the counter surface 45 onto the sealing surface 41 is shown when the first roller 3 and the axis 25 are in a position corresponding to a first width of the gap 7. A second projection 69 of the counter surface 45 onto the sealing surface 41 corresponds to a configuration when the first roller 3 and the axis 25 are in a position corresponding to a second width of the gap 7 being greater than the first width of the gap 7.

As shown in FIG. 4 the counter surface 45 remains onto the sealing surface completely in the area of the low pressure area 17 thus ensuring sealing of the low pressure area 17 at the lateral surfaces of the roller 3, 5 for the different gap widths, i.e. differently closed and/or opened roller gaps.

Outside the low pressure area the sealing component means 39, in particular the sealing surface, provides a tongue element 71. By the tongue element 71 it is ensured that the counter surface 45 if sufficiently supported by the sealing surface also outside the low pressure area 17 without negatively influencing the movability of the first axis 25.

In FIG. 5 the elements of the sealing system 17, in particular the sealing component 31 are shown in an exploded view from a different perspective compared to FIGS. 3 and 4, respectively.

In FIGS. 6a and 6b detailed views of the sealing element 31 are shown. As can be taken from the FIGS. 6a and 6b the sealing element 31 comprises a sealing element means 73. The sealing element means 73 is formed as a sliding sealing element. It is movable in a direction D and contacts the rolling surface 35 of the first roller 3. Although the first roller 3 is shown, the sealing element 31 of the second roller 5 is configured accordingly.

The sealing element means 73 contacts the rolling surface 35 in the area of a contact surface 75 that in particular extends parallel to the first axis 25. The sealing element means 73 is biased onto the rolling surface 35 by spring elements 77. In case the first roller 3 is moved to adjust the gap 7, the distance between the mount 79 that remains fixed in the space and the contact surface 75 increases or decreases due to the curvature of the rolling surface 35. This change in the distance is compensated by the movement of the sealing element means 73 ensuring a steady contact of the sealing element 31 with the rolling surface 35 and thus a constant quality of the sealing.

In FIG. 7 a second embodiment of a multi-roller system 101 according to the claimed subject matter is shown. The elements of the multi-roller system 101 that correspond to the elements of the multi-roller system 1 have the same reference numbers, however increased by 100.

The multi-roller system 101 is in particular used in configurations in which turbulences within the powder material are more likely. This can be due to the powder material itself, like its weight or particle size, due to comparable larger gaps 107 to be used to produce comparable thicker material webs 111 or just to further increase the ability to avoid air inclusions within the material web 111. In particular when lager gaps 107 are existing the atmospheric pressure acting on the gap 7 in the multi-roller system 1 exerts an increased force onto the system 1, in particular the gap 7 and the powder material 9. This might result in an air flow through the gap 7 into the low pressure area 17 and the low pressure chamber 21, respectively. This can lead to turbulences within the powder material 9 resulting in pores or irregularities in the web 11.

These effects are avoided in the multi-roller system 101. By adding a second low pressure area 181 in the area of the second, optionally fixed, roller 105 and an, optionally loose, third roller 183 it is possible that on the side of the gap 107 being opposite the first low pressure area 117 and first low pressure chamber 121, respectively, a pressure lower than the pressure of the environment of the multi-roller system 101, in particular lower than atmospheric pressure is acting. For this purpose between the first low pressure area 117 and the environment the second low pressure area 181 is located. This second low pressure area 181 is fluidly connected to a second low pressure chamber 185. With the help of a vacuum pump 187 a pressure below the pressure of the environment can be generated that is especially above the pressure within the first low pressure area 117 and the low pressure chamber 121, respectively. But also the same pressure might exist in the first low pressure chamber 121 and the second low pressure chamber 185.

The first low pressure chamber and the second low pressure chamber are sealed with respect to each other by the sealing system of the first low pressure area 117 and further sliding sealing elements 189. The web 111 is picked up by the roller 183 when exiting the gap 107 and guides it outward the second low pressure area 181, optionally having a sealing system corresponding to the sealing system 19 to allow a relative movement of the second roller 105 and the third roller 183, optionally to adapt a width of a second gap between the second, optionally fixed, roller 105 and the, optionally loose, third roller 183, in particular to adapt the width of the second gap to the width of the first gap formed between the first, optionally loose, roller 103 and the second roller 105. Furthermore, a sliding sealing element 191 is used to seal the low pressure chamber 185 in the area of the third roller 183.

The multi-roller system 101 has the advantage that the air from the environment coming in though a gap between the rollers 105 and 183 comes into contact with the formed web 111 instead of the powder material 109. Powder turbulences can be avoided, at least reduced.

It has to be understood that further low pressure areas and chambers might be added in serial to reduce the pressure from the environment to the pressure in the first low pressure chamber in a cascaded way.

In FIG. 8 a further alternative embodiments of a multi-roller system 101′ is shown. The elements of the Multi-roller system 101′ that correspond to the elements of the Multi-roller system 101 have the same reference number, however with one apostrophe. In contrast to the Multi-roller system 101, the Multi-roller system 101′ comprises beside the first, optionally loose, roller 103′, the second, optionally fixed, roller 105′ and the, optionally loose, third roller 183′ a fourth, optionally fixed, roller 193′. In this embodiment the second gap is formed between a third roller 183′ and the further fourth roller 193′. This configuration allows to transfer the web 111′ along a straight line. Furthermore easily further low pressure areas and low pressure chambers can be added in serial to the first low pressure chamber 121′ and the second pressure chamber 185′ as well as the first low pressure area 117′ and the second low pressure area 181′.

In FIG. 9 a detail of a preferred sealing element 31 is shown. In order to compensate for any length changes of the rollers 3, 5, in particular due to temperature changes and to ensure a reliable sealing the sealing element 31 comprises two parts 31a, 31b being moveable in a direction E along the axis of the roller relative to each other. The two parts 31a, 31b are gliding relative to each other such that the surfaces of the parts 31a, 31b, remaining at least partly in contact with each other to ensure a secure sealing. In particular the parts 31a, 31b are interlocking with each other or mesh with each other.

The features disclosed in the specification, the claims and the figure may be essential to the invention in its various embodiments, either individually or in any combination.

### REFERENCE SIGN LIST

1 multi-roller system
3 roller
5 roller
7 gap
9 powder material
11 web
13 conveyor device
15 powder material feed
17 low pressure area
19 sealing system
21 low pressure chamber
23 vacuum pump
25 axis
27 axis
29 sealing component
31 sealing element
33 opening
35 rolling surface
37 rolling surface
39 sealing component means
41 sealing surface
43 sealing surface
45 counter surface
47 counter surface
49 retaining element
49a, 49b retaining element
51a, 51b opening
53a, 53b bearing element
55a, 55b fastening element
57 tongue groove connection
59 spring element
61 opening
63 horizontal border
65 vertical border
67 projection
69 projection
71 tongue element
73 sealing element means
75 contact surface
77 spring element
79 mount
101, 101′ multi-roller system
103, 103′ roller
105, 105′ roller
107, 107′ gap
109, 109′ powder material
111, 111′ web
113, 113′ conveyor device
115, 115′ powder material feed
117, 117′ low pressure area
121, 121′ low pressure chamber
123, 123′ vacuum pump
181, 181′ low pressure area
183, 183′ roller
185, 185′ low pressure chamber
187, 187′ vacuum pump
189, 189′ sliding sealing element
191, 191′ sliding sealing element
193′ roller
A detail
D, E direction
R radial direction

1. Multi-roller system comprising at least two rollers forming at least one first gap therebetween configured to be supplied with at least one powder material to produce at least one film material and/or web material by compressing the powder material within the first gap, wherein at least one first low pressure area is provided in at least one supply area for the powder material and the first gap, wherein at least one sealing system is provided to seal the first low pressure area, wherein the sealing system contacts at least one surface of at least one of the rollers, characterized in that
a first roller is movable relative to a second roller to alter a width of the first gap and/or to alter a distance between the first roller and the second rollers wherein the sealing system is adjustable to at least two different widths of the first gap and/or two distances of the first roller and the second roller.

2. Multi-roller system according to claim 1, wherein
at least one first roller is rotating around a first axis and at least one second roller is rotating around a second axis, wherein optionally the first axis and the second axis are at least partly parallel to each other.

3. Multi-roller system according to claim 2, wherein
the sealing system comprises at least one sealing component, wherein the sealing component seals the first low pressure area relative to at least a part of the environment of the multi-roller system, in particular at an end face of the rollers, optionally the first roller and/or the second roller, and/or has at least one sealing surface having a normal vector parallel to an axial direction of the first axis and/or the second axis.

4. Multi-roller system according to claim 3, wherein
the sealing component comprises at least one first sealing component with a first sealing surface and at least one second sealing component with a second sealing surface, wherein optionally the first sealing component and the second sealing component are at least partly connected to each other or at partly formed as a single piece.

5. Multi-roller system according to claim 3, wherein
the first roller has at least one first counter surface and the second roller has at least one second counter surface, wherein optionally the first counter surface contacts the sealing component, optionally the sealing surface, optionally the first counter surface contacts the first sealing component, optionally the first sealing surface, and/or the second counter surface contacts the second sealing component, optionally the second sealing surface.

6. Multi-roller system according to claim 3, wherein
the first axis and/or the second axis is/are at least partly reaching through the sealing component, at least one opening within the sealing component, optionally the first axis is at least partly reaching through the first sealing component, optionally a first opening within the first sealing component, and/or the second axis is at least partly reaching through the second sealing component, optionally a second opening within the second sealing component.

7. Multi-roller system according to claim 6, wherein
the opening, optionally the first opening and/or the second opening, is at least partly elongated, optionally elliptical, optionally the first opening is at least partly elongated, optionally elliptical, and the second opening is at least partly circular or the second opening is at least partly elongated, optionally elliptical, and the first opening is at least partly circular.

8. Multi-roller system according to claim 3, wherein
the sealing surface, optionally the first sealing surface and/or the second sealing surface, is at least partly elongated, optionally elliptical, optionally the first opening and the first sealing surface are at least partly elongated, optionally elliptical, and the second opening and the second sealing surface are at least partly circular, or the second opening and the second sealing surface are at least partly elongated, optionally elliptical, and the first opening and the first sealing surface are at least partly circular.

9. Multi-roller system according to claim 3, wherein
the first counter surface and/or the second counter surface comprises at least one counter material, optionally at least one ceramic material, at least one metal material, at least one plastic material, at least one hardened material, hardened steel, at least one glass material, at least one polymer material, at least one polyether ether ketone material, at least one alloy material, at least one tungsten nitride material and/or at least one wolfram carbide material, and/or the first counter surface comprises at least one coating of at least a part of the first roller, optionally the end face of the first roller, and/or the second counter surface comprises at least one coating of at least a part of the second roller, optionally the end face of the second roller, and/or the first counter surface comprises at least one first counter surface element attached, optionally attached in a turnable safe manner, to the first roller, optionally the end face of the first roller, and/or the second counter surface comprises at least one second counter surface element attached, optionally attached in a turnable safe manner, to the second roller, optionally the end face of the second roller.

10. Multi-roller system according to claim 1, wherein
the sealing system, optionally the sealing component, comprises at least one retaining element, wherein optionally the retaining element forces/biases a sealing component means, optionally the sealing surface, onto the first counter surface and the second counter surface, optionally the retaining element comprises at least one first retaining element forcing/biasing the first sealing component, optionally the first sealing surface, onto the first counter surface, and/or at least one second retaining element forcing/biasing the second sealing component, optionally the second sealing surface, onto the second counter surface.

11. Multi-roller system according to claim 10, wherein
the first retaining element is movable relative to the second retaining element, optionally in a radial direction (R) of the first axis and/or the second axis and/or a direction perpendicular to the first axis and/or the second axis.

12. Multi-roller system according to claim 11, wherein
the first retaining element and the second retaining element are guided relative to each other, optionally by at least one tongue and groove connection.

13. Multi-roller system according to claim 10, wherein
the first retaining element is securely connected in a longitudinal direction perpendicular to the first axis to the first axis and/or the second retaining element is securely connected in a longitudinal direction perpendicular to the second axis to the second axis and/or the first axis is turnable mounted within the first retaining element, preferably by at least one first sealing bearing and/or the second axis is turnable mounted within the second retaining element, preferably by at least one second sealing bearing.

14. Multi-roller system according to claim 13, wherein
the first bearing element is held relative to and/or within the first retaining element by at least one first fastening element and/or the second bearing element is held relative to and/or within the second retaining element by at least one second fastening element.

15. Multi-roller system according to claim 3, wherein
the sealing component, optionally the sealing surface, in particular the first sealing component and/or the second sealing component, optionally the first sealing surface and/or the second sealing surface, comprises at least partly at least one second material, optionally, at least one metal material, at least one plastic material, at least one hardened material, hardened steel, at least one glass material, at least one polymer material, at least one polyether ether ketone material, at least one alloy material, at least one tungsten nitride material and/or at least one wolfram carbide material, in particular in an area contacting the first counter surface and/or the second counter surface.

16. Multi-roller system according to claim 1, wherein
the sealing system comprises at least one sealing element, optionally sliding sealing element, wherein the sealing element seals the first low pressure area, in particular relative to at least a part of the environment of the multi-roller system, along a rolling surface of the roller, optionally by sliding at least partly on at least a part of the rolling surface of the roller, and/or has at least one contact surface with at least one of the rollers, in particular a rolling surface, extending parallel to the first axis and/or the second axis, and/or having a normal vector perpendicular to an axial direction of the first axis and/or the second axis.

17. Multi-roller system according to claim 16, wherein
the sealing element, optionally a sealing element means of the sealing element is movable in a direction onto the rolling surface of the first roller and/or the second roller and/or perpendicular to the first axis and/or the second axis and/or the sealing element, optionally the sealing element means is forced onto the surface of the first roller and/or the second roller, optionally by at least one biasing and/or spring element.

18. Multi-roller system according to claim 16, wherein
the direction of movement of the sealing element, optionally the sealing element means and the normal direction of the contact surface of the rolling surface of the first roller and/or the second roller
(i) enclose a first angle, optionally angle of attack, in a first relative position of the first roller and the second roller, a first relative position of the first axis and the second axis and/or a first width of the first gap, and
(ii) enclose a second angle, optionally angle of attack, in a second relative position of the first roller and the second roller, a second relative position of the first axis and the second axis and/or a second width of the first gap,
wherein the first angle and the second angle are different.

19. Multi-roller system according to claim 16, wherein
the sealing element comprises at least two sealing element parts that are movable relative to each other in a direction at least partly parallel to the first axis and/or the second axis.

20. Multi-roller system according to claim 16, wherein
the sealing element comprises a first sealing element, optionally a first sliding sealing element, contacting, in particular glidingly, the first roller, optionally the rolling surface of the first roller, and at least one second sealing element, optionally a second sliding sealing element, contacting, in particular glidingly, the second roller, optionally the rolling surface of the second roller.

21. Multi-roller system according to claim 1, wherein
the system comprises at least one second low pressure area being located opposite the first low pressure area and/or the supply area relative to the first roller and/or the second in roller and/or opposite the first low pressure area and/or the supply area relative to the first gap.

22. Multi-roller system according to claim 21, wherein
within the first low pressure area a first pressure is present and in the second low pressure area a second pressure is present, wherein optionally the first pressure and the second pressure are below a pressure in the environment of the multi-roller system and/or wherein optionally the first pressure is lower than the second pressure.

23. Multi-roller system according to claim 21, wherein
the multi-roller system comprises at least one third roller, wherein optionally at least one second gap is formed
(i) between the first roller and the third roller,
(ii) between the second roller and the third roller, or
(iii) between the third roller and a fourth roller,
and/or material exiting the first gap is conveyed through the second gap.

24. Multi-roller system according to claim 1, characterized by
at least one vacuum pump connected to the first low pressure area and/or the second low pressure area, optionally at least one first vacuum pump connected to the first low pressure area and/or at least one second vacuum pump being connected to the second low pressure area.
